(19) United States
(12) Patent Application Publication
(10) Pub. No.: US 2026/0299626 A1
(43) Pub. Date: Oct. 1, 2026

(54) A TEMPERATURE REGULATING SYSTEM WITH FEEDBACK LOOP FOR THERMAL RESPONSE ADAPTATION

(71) Applicant: CLIM8, LIMONEST (FR)

(72) Inventors: Julien GUERITEE, EVEUX (FR); Florian MIGUET, VENISSIEUX (FR)

(21) Appl. No.: 19/474,747

(22) PCT Filed: Apr. 11, 2023
(86) PCT No.: PCT/EP2023/059463

§ 371 Date: Oct. 13, 2025

(51) Int. Cl. G05D 23/19; A41D 13/005; G05D 101/00

(52) U.S. Cl. CPC G05D 23/1902; A41D 13/0051; A41D 13/0053; G05D 2101/22

(57) ABSTRACT

The invention relates to a temperature regulation system for regulating the temperature of a user's body.

The system comprises temperature sensors 1, temperature adjustment element 2, a memory unit 3 to store a thermal response in association with a type of user activity, said thermal response defining when the temperature adjustment element 2 has to be activated and deactivated based on an instant temperature related value, and a controlling unit 4 for determining an instant temperature related value from a measurement received from the temperature sensor 1 and for activating the temperature adjustment elements 2 depending on the thermal response and the instant temperature related value.

The system further comprises a user module 5 for obtaining an instant type of user activity information from the user to indicate that the user starts an activity corresponding to the instant type of user activity information, transmitting this instant type of user activity information to the controlling unit 4, obtaining feedback information from the user, said feedback information comprising at least one level value associated with at least one indicator related to the working of the system, and transmit said feedback information to an analyzing module 8.

The analyzing module 8 analyzes feedback information to determine one or more adaptation values, adapt the thermal response accordingly to generate an adapted thermal response, and transmit the adapted thermal response to the controlling unit 4 for storing it in the memory unit 3 in association with the type of user activity corresponding to the instant type of user activity information.

### FIELD OF THE INVENTION

The present invention relates to a temperature regulation system for regulating the temperature of a portion of a body, in particular of a user's body.

### BACKGROUND OF THE INVENTION

Thermal comfort is driven by the temperature inside a person's body and the temperature at the surface of your body. Deep body temperature of a person is generally 37° C. and the mean skin temperature of a person is generally 33° C. People become uncomfortable in a thermal sense when the environment changes for example, increased wind or extra sunny day, or when a person moves to a cooler place. In common situations, discomfort in a thermal sense is felt by a user when the user's skin temperature changes, rather than a change in core body temperature.

Conventional chemical or electric heating systems used in clothing can easily deliver heat at relatively high levels. Most currently available devices consist of a wearable garment with heating pads that can be manually adjusted by the user. In at least some devices the heating pads produce an equal heat output and all the heating pads are activated to provide heat. Existing products are often bulky, heavy, require manual operation and are limited in their range of operation.

When a user initiates a session of use of such a system, the latter might be configured with a default thermal response which has been set up by the user himself or herself. This thermal response, for a given user, can vary depending on the activity, like hunting, riding, running, etc., Therefore, a default thermal response for a given activity may not be suitable for another activity. It is therefore difficult to provide to a user a satisfying default thermal response for any activity of interest for this user.

Some systems allow the user to adapt the thermal response in some way, in real time when the system is in use, to correct the unsatisfying thermal response. The user corrected thermal response is then stored and immediately used instead of the previous thermal response. Depending on the user and on the activity, it might be that the user corrects several times the thermal response during one session of use, because of errors or of versatile sensations. Besides, the desired thermal response for a given user generally varies from a type of activity to another type of activity, which is usually not or insufficiently accounted of with such systems. Further, such systems come with no or unadapted default thermal response proposed to a user for a given type of activity.

### SUMMARY OF THE INVENTION

The invention aims therefore at solving the above-mentioned problems, amongst other problems.

To this end, the invention proposes a temperature regulated system with intelligent adaptation of the thermal response depending on the type of user activity and user feedback.

According to a first aspect, the object of the invention is a temperature regulation system for regulating the temperature of a user's body, comprising at least one temperature sensor adapted to generate a measurement related to an instant temperature of a given portion of a user's body, at least one temperature adjustment element adapted to provide heat and/or cold to at least a part of the user's body, a memory unit adapted to store a thermal response in association with one or more types of user activity, said thermal response defining when the temperature adjustment element has to be activated and deactivated based on an instant temperature related value, and a controlling unit in wire or wireless communication with the memory unit, with the temperature sensor and with the temperature adjustment element, configured, for a given type of user activity, to receive a measurement from the temperature sensor, to determine an instant temperature related value from the received measurement, and to activate the temperature adjustment element depending on the thermal response and the instant temperature related value.

The system further comprises a user module and an analyzing module in wire or wireless communication with each other and with the controlling unit.

The module is configured to obtain an instant type of user activity information from the user to indicate that the user starts an activity corresponding to the instant type of user activity information, transmit said instant type of user activity information to the controlling unit, obtain feedback information from the user, said feedback information comprising at least one level value associated with at least one indicator related to the working of the system, and transmit said feedback information to the analyzing module.

The analyzing module is configured to analyze feedback information to determine one or more adaptation values, adapt the thermal response based on the adaptation values to generate an adapted thermal response, and transmit said adapted thermal response to the controlling unit.

The controlling unit is further configured to store the adapted thermal response in the memory unit in association with the type of user activity corresponding to the instant type of user activity information.

In some embodiments, the system further comprises one or more of the following features, considered alone or according to any technically possible combination:
the analyzing module is configured to measure the duration of use of the system after the user module obtains from the user the instant type of user activity information, and to transmit said duration of use to the user module, said user module being configured to obtain the feedback information from the user when said duration of use is greater than a predetermined duration;
the analyzing module is further configured to determine when the user stops the activity corresponding to the instant type of user activity information, and to transmit to the user module an information that the user has stopped the activity corresponding to the instant type of user activity information, said user module being configured to obtain the feedback information from the user after the user has stopped said activity corresponding to the instant type of user activity information;
the analyzing module 8 is further configured to obtain an end of activity information from the user in order to determine when the user stops the activity corresponding to the instant type of user activity information;
the user module and the analyzing module are further configured to establish a connection with the controlling unit before any communication with said controlling unit, the analyzing module being configured to obtain an end of activity information when said connection stops, in order to determine when the user stops the activity corresponding to the instant type of user activity information;
the analyzing module is further configured to obtain an end of activity information from the controlling unit in order to determine when the user stops the activity corresponding to the instant type of user activity information;
the controlling unit is further configured to determine automatically that the user stops the activity corresponding to the instant type of user activity information, and to send the end of activity information to the analyzing module accordingly;
the system further comprises movement and/or position detection means in wire or wireless communication with the controlling unit, the controlling unit being further configured to determine automatically that the user stops the activity corresponding to the instant type of user activity information by receiving from said detection means an absence of movement information or a predetermined type of movement or of succession of movements information, and/or a predetermined position information;
the analyzing is configured to measure a duration between the moment when the user stops the activity corresponding to the instant type of user activity information, and the moment when the feedback information is obtained from the user, and to analyze the feedback information only if said duration is smaller or equal to a predetermined duration;
the user module is configured to obtain the feedback information only if the time elapsed since the user has stopped the activity corresponding to the instant type of user activity information is smaller or equal to a predetermined duration;
the user module is configured to obtain the feedback information from the user after having obtained N times from the user an instant type of user activity information corresponding to the same type of user activity, where N is comprised between 2 and a predetermined value p, preferably N is equal two p, with p being greater than 2, preferably p being equal to 5;
the thermal response is defined at least by a start temperature value, a stop temperature value, and an electrical power value, the controlling unit being configured to activate the temperature adjustment element with an electrical power corresponding to the electrical power value, when the instant temperature is smaller or equal to the start temperature value, and to deactivate the temperature adjustment element when the instant temperature is greater than the stop temperature value;
at least one of the indicators is related to the start temperature or to the stop temperature or to the electrical power;
the analyzing module is configured to analyze the level corresponding to the indicator in the feedback information to determine a corresponding adaptation value, and to modify the start temperature value or the stop temperature value, or the electrical power value, based on the corresponding adaptation value;
the system further comprises a user device and a controlling device, the user module being part of the user device, the controlling unit being part of the controlling device, the analyzing module and the memory being part of the user device or the controlling device or being distributed in the user device and the controlling device;
the user module is further configured to transmit the feedback information to a remote central computer system configured to adapt a default thermal response associated with a group of users and with the type of user activity corresponding to the instant type of user activity information, based on the feedback information;
the controlling unit is further configured to connect to the remote central computer system, to download from said remote central computer system a default thermal response corresponding to a given user activity and to a given group of users when no thermal response for the given user activity is stored in the memory unit, and to store said default thermal response in said memory.

According to a second aspect, the object of the invention is a central computer system comprising a memory module configured to store feedback information transmitted by a plurality of systems as presented above, and to store default thermal responses associated with groups of users and types of user activity, and comprising a controlling module configured to analyze all the feedback information corresponding to a given group of users for a given type of user activity to determine one or more adaptation values, and to adapt the corresponding default thermal response stored in the memory module based on the determined adaptation values.

According to a third aspect, the object of the invention is a garment to be worn by a human or animal user comprising a temperature regulation system as presented above.

According to a fourth aspect, the object of the invention is a method for regulating the temperature of a user's body, comprising generating, using at least one temperature sensor, a measurement related to an instant temperature of a given portion of a user's body, providing, using at least one temperature adjustment element, heat and/or cold to at least a part of the user's body, storing, in a memory unit, a thermal response in association with one or more types of user activity, said thermal response defining when the temperature adjustment element has to be activated and deactivated based on an instant temperature related value, receiving, using a controlling unit in wire or wireless communication with the memory unit, with the temperature sensor and with the temperature adjustment element, for a given type of user activity, a measurement from the temperature sensor, determining, using said controlling unit, an instant temperature value from the received measurement, and activating, using said controlling unit, the temperature adjustment element depending on the thermal response and the instant temperature related value.

The method also comprises obtaining, using a user module in wire or wireless communication with the controlling unit, an instant type of user activity information from the user to indicate that the user starts an activity corresponding to the instant type of user activity information, transmitting, using said user module, said instant type of user activity information to the controlling unit, obtaining, using said user module, feedback information from the user, said feedback information comprising at least one level value associated with at least one indicator related to the working of the system, transmitting, using said user module, said feedback information to an analyzing module in wire or wireless communication with the controlling unit and the user module.

The method further comprises analyzing, using said analyzing module, the feedback information to determine one or more adaptation values, adapting, using said analyzing module, the thermal response based on the adaptation values for generating an adapted thermal response, transmitting, using said analyzing module, the adapted thermal response to the controlling unit, storing, using the controlling unit, the adapted thermal response in the memory unit in association with the type of user activity corresponding to the instant type of user activity information.

In some embodiments, the method further comprises one or more of the following features, considered alone or according to any technically possible combination:
the method further comprises measuring, using the analyzing module, the duration of use of the system after having obtained from the user the instant type of user activity information, transmitting, using said analyzing module, said duration of use to the user module, obtaining, using said user module, the feedback information from the user when the duration of use is greater than a predetermined duration;
the method further comprises determining, using the analyzing module, when the user stops the activity corresponding to the instant type of user activity information, transmitting, using said analyzing module, an information that the user has stopped the activity corresponding to the instant type of user activity information to the user module, obtaining, using said user module, the feedback information from the user is after the user has stopped said activity corresponding to the instant type of user activity information;
the method further comprises obtaining, using the analyzing module, an end of activity information from the user in order to determine when the user stops the activity corresponding to the instant type of user activity information;
the method further comprises establishing, using the user module, a connection with the controlling unit before any communication with said controlling unit, obtain, using the analyzing module, an end of activity information when said connection stops, in order to determine when the user stops the activity corresponding to the instant type of user activity information;
the method further comprises obtaining, using the analyzing module, an end of activity information from the controlling unit in order to determine when the user stops the activity corresponding to the instant type of user activity information;
the method further comprises determining automatically, using the controlling unit, that the user stops the activity corresponding to the instant type of user activity information, and sending, using said controlling unit, the end of activity information to the analyzing module accordingly;
the method further comprises receiving, using the controlling unit, from a movement and/or position detection means in wire or wireless communication with the controlling unit, an absence of movement information or a predetermined type of movement or of succession of movements information, and/or an predetermined position information, determining automatically, using the controlling unit, that the user stops the activity corresponding to the instant type of user activity information, based on the information received from said detection means;
the method further comprises measuring, using the analyzing, a duration between the moment when the user stops the activity corresponding to the instant type of user activity information, and the moment when the feedback information is obtained from the user, analyzing, using said analyzing module, the feedback information only if said duration is smaller or equal to a predetermined duration;
the method further comprises obtaining, using the user module, the feedback information only if the time elapsed since the user has stopped the activity corresponding to the instant type of user activity information is smaller or equal to a predetermined duration.
the method further comprises obtaining, using the user module, the feedback information from the user after having obtained N times from the user an instant type of user activity information corresponding to the same type of user activity, where N is comprised between 2 and a predetermined value p, preferably N is equal two p, with p being greater than 2, preferably p being equal to 5;
the thermal response is defined at least by a start temperature value, a stop temperature value, and an electrical power value, the method further comprising activating, using the controlling unit, the temperature adjustment element with an electrical power corresponding to the electrical power value, when the instant temperature is smaller or equal to the start temperature value, deactivating, using the controlling unit, the temperature adjustment element when the instant temperature is greater than the stop temperature value;
at least one of the indicators is related to the start temperature or to the stop temperature or to the electrical power;
the method further comprises analyzing, using the analyzing module, the level corresponding to the indicator in the feedback information to determine a corresponding adaptation value, modifying, using said analyzing module, the start temperature value or the stop temperature value, or the electrical power value, based on the corresponding adaptation value;
the method further comprises transmitting, using the user module, the feedback information to a remote central computer system, adapting, using said remote central computer, a default thermal response associated with a group of users and with the type of user activity corresponding to the instant type of user activity information, based on the feedback information;
the method further comprises connecting, using the controlling unit, to the remote central computer system, downloading from said remote central computer system, using said controlling unit, a default thermal response corresponding to a given user activity and to a given group of users when no thermal response for the given user activity is stored in the memory unit;
the method further comprises using a memory module of the central computer system for storing feedback information received from a plurality of systems as presented above, and for storing default thermal responses associated with groups of users and types of user activity, and using a controlling module of said central computer system for analyzing all the feedback information corresponding to a given group of users for a given type of user activity to determine one or more adaptation values, and for adapting the corresponding default thermal response stored in the memory module based on the determined adaptation values.

Therefore, the temperature regulation system of the invention intelligently records feedback information from the user in the framework of a given type of activity, and is able to provide the user with a better experience for next session of use in this framework. Besides, the temperature regulation system and the central computer system are able to provide a user with a default thermal response for a given type of activity, and a given group of users, based on many user's experiences for many users. Such a default thermal response is more relevant, very close to the user needs, thus requires less further adaptation.

### DRAWINGS

The invention and its advantages may be better understood by referring to the description which follows, given as example and for illustrative purpose only, and by referring to the accompanying drawing listed below:

FIG. 1: illustrates an example of temperature regulation system and of a central computer system of the invention;

FIG. 2: illustrates another example of temperature regulation system and of a central computer system of the invention.

### DETAILED DESCRIPTION

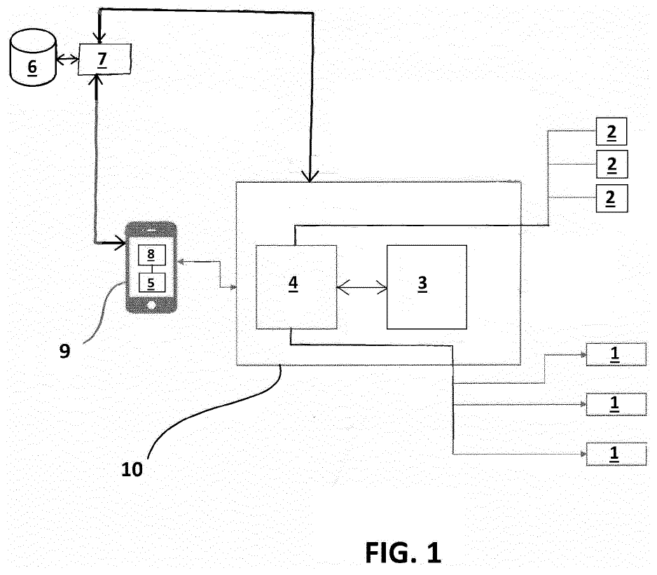

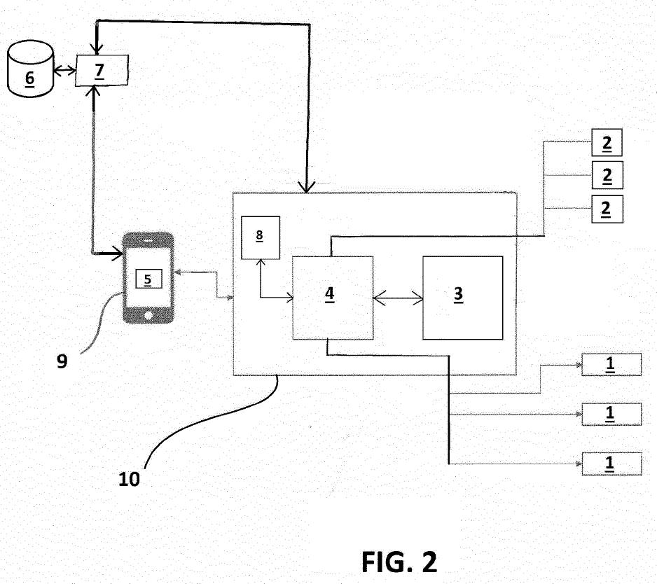

Two examples of a system for regulating the temperature of the body of a user, such as the body of a human or of an animal, are illustrated respectively in FIGS. 1 and 2.

The system comprises one or more temperature sensors 1, precisely in the example of FIG. 1, three temperature sensors 1. It comprises also one or more temperature adjustment elements 2, precisely in the example of FIG. 1, three temperature adjustment elements 2.

The system further comprises a memory unit 3, a controlling unit 4, a user module 5 and an analyzing module 8.

In the example of FIG. 1, the user module 5 and the analyzing module 8 are part of a user device 9, while the controlling unit 4 and the memory unit 3 are part of a controlling device 10. In the example of FIG. 2, the user module 5 is part of the user device 9, while the analyzing module 8, the controlling unit 4 and the memory unit 3 are part of a controlling device 10. Other distributions are possible, as explained at the end of this description, for example with the analyzing module distributed over the user device 9 and the controlling device 10.

The temperature sensors 1 are adapted to generate a measurement related to an instant temperature of a given portion of the user's body. Preferably the measurement is a skin temperature. This measurement can be the instant temperature itself, or a mean temperature calculated over a given period of time, such as a few seconds, or even a positive or negative derivative of the temperature over a given period of time.

The temperature adjustment element 2 is adapted to provide heat and/or cold to at least a part of the user's body. It can be any suitable element or device to provide heat or cold to a user. For example, it can be a heating or cooling pad that can be positioned on a wearable garment, and arranged in direct contact with the user's skin or in contact through a layer of textile, to provide heat or cold to a portion of the user's body.

The memory unit 3 is adapted to store a thermal response in association with one or more types of user activity. Such a thermal response defines when the temperature adjustment element has to be activated and deactivated based on an instant temperature related value.

The controlling unit 4 is in wire or wireless communication with the memory unit 3, with the temperature sensors 1, with the temperature adjustment elements 2, with the user module 5, and with the analyzing module 8. This analyzing module 8 is also in wire or wireless communication with the user module 5. The controlling unit 4 is configured, for a given type of user activity, to receive a measurement from the temperature sensors 1, to determine an instant temperature related value from the received measurement, and to activate the temperature adjustment elements 2 depending on the thermal response and the instant temperature related value.

The controlling unit 4 receives temperature measurements as electronic signals from the temperature sensors 1, and is configured to process these temperature measurements.

The user module 5 is configured to obtain an instant type of user activity information from the user to indicate that the user starts an activity corresponding to the instant type of user activity information, and transmit this information to the controlling unit 4.

The user module 5 is also configured to obtain feedback information from the user, for example through a user interface of the user module 5, and to transmit this feedback information to the analyzing module 8. This feedback information comprises one or more level values associated with one or more indicators related to the working of the system. By working of the system, it is meant how efficiently the system regulates the temperature.

As mentioned above, the temperature is regulated on the basis of a thermal response. In an example, the thermal response is defined at least by a start temperature value, a stop temperature value, and an electrical power value. In this case, the controlling unit 4 is configured to activate the temperature adjustment element 2 with an electrical power corresponding to the electrical power value, when the instant temperature is smaller or equal to the start temperature value, and to deactivate the temperature adjustment element 2 when the instant temperature is greater than the stop temperature value.

In this context, the one or more indicators mentioned above, related to the working of the system, can be related to the start temperature, or to the stop temperature, or to the power value, or to a combination of the three, Preferably, three indicators are used, one related to the start temperature, one related to the stop temperature, and one related to the power value.

The feedback information obtained by the user module comprises at least one level value for each of these indicators:
indicator “start temperature”: level value amongst {“too early”; “too late”; “good”}
indicator “stop temperature”: level value amongst {“too early”; “too late”; “good”}
indicator “power value”: level value amongst {“too high”; “too low”; “good”}.

The analyzing module 8 is configured to analyze the feedback information, received from the user module 5, to determine one or more adaptation values, and adapt the thermal response to generate an adapted thermal response based on the adaptation values, and further configured to transmit the adapted thermal response to the controlling unit 4. This controlling unit is further configured to store the adapted thermal response in the memory unit 3 in association with the type of user activity corresponding to the instant type of user activity information.

In the example mentioned above, the analyzing module 8 analyzes the level corresponding to the indicator in the feedback information, and determines corresponding adaptation values. These adaptation values are received by the controlling unit 4 to modify the start temperature value and/or the stop temperature value, and/or the electrical power value accordingly.

For example, a given feedback information for the three indicators mentioned above can be: {“start temperature”; “stop temperature”; “power value”}={“too late”; “too early”; “good”}.

In such a case, the adaptation values determined by the user module 5 can be:
adaptation of the start temperature: δₛₜₐᵣₜ
adaptation of the stop temperature: δₛₜₒₚ
adaptation of the power value: 0

The thermal response is then adapted accordingly:

$$start temperature : {T}_{start - new} = {T}_{start} + {δ}_{start}$$

$$stop temperature : {T}_{stop - new} = {T}_{stop} + {δ}_{stop}$$

$$adaptation of the power value : {P}_{new} = P$$

If, in another example, the level values in the feedback information for the start temperature and for the stop temperature are respectively “too early” and “too late”, it leads to the following corresponding adaptation of the thermal response:

$$start temperature : {T}_{start - new} = {T}_{start} - {δ}_{start}$$

$$stop temperature : {T}_{stop - new} = {T}_{stop} - {δ}_{stop}$$

As explained before (see also at the end of the description), analyzing module 8 may be distributed over the user device 9 and the controlling device 10. For example, a part of the analyzing module may be distributed in the user device 9, and be configured for analyzing feedback information to determine the adaptation values, for sending these adaptation values to another part of the analyzing module 8 distributed in the controlling device 10. This other part of the analyzing module 8 is then configured to adapt the thermal response to generate the adapted thermal response, based on the received adaptation values, and transmit this adapted thermal response to the controlling unit 4.

The user device 9 is provided with a user interface that allows the user to enter the feedback information, and that allows the user module 5 to receive this feedback information. This user device 9 is preferably a portable device. It can be, for example, a smartphone or a tablet. It is adapted for two-way communication with the controlling device 10.

Preferably, the duration of use of the system for a given activity is measured, in order to make sure that the session of use has been long enough to render the feedback more relevant. The start of the session is considered as being the moment when the user module 5 obtains from the user the instant type of user activity information.

In this specific embodiment, the analyzing module 8 is configured to measure the duration of use of the system after the user module 5 obtains from the user the instant type of user activity information. The analyzing module 8 then transmit said duration of use to the user module. Then, obtaining the feedback information from the user, using the user module 5 for example by prompting the user to do so on the user interface of the user device 9, is performed when said duration of use is greater than a predetermined duration. This predetermined duration might depend on the type of activity, and/or the profile of the user, and/or other parameters such as environmental parameters. For example, this predetermined duration could be 15 minutes or of the order of 15 minutes.

In another specific embodiment, alone or in combination with the previous embodiment, the analyzing module 8 is configured to determine when the user stops the activity corresponding to the instant type of user activity information, and to transmit to the user module 5 an information that the user has stopped the activity corresponding to the instant type of user activity information Then, obtaining the feedback information from the user, using the user module 5 for example by prompting the user to do so on the user interface of the user device 9, is performed after the user has stopped this activity corresponding to the instant type of user activity information.

Determining by the analyzing module 9 that the user stops the activity corresponding to the instant type of user activity information, can be done by obtaining an end of activity information from the user. Such an end of activity information can be obtained through an action of the user, such as an input of the user through the user interface of the user device 9, which is transmitted to the analyzing module 8. Such an input can be a manual logging out of the user from this interface, a manual closing of this interface, or a manual entry on the interface.

Before starting to communicate with the controlling unit 4, the user module 5 and the analyzing device 8 establishes a connection with this controlling unit 4. This may be a connection established between the user device 9 and the controlling unit 4, which is used by the user module 5, and the analyzing device 8 when the latter is at least partly integrated in the user device 9, to communicate with the controlling unit 4. An end of activity information may then be obtained when this connection between the user module 5 and the analyzing module 8 on one hand, and the controlling unit 4 the other hand, stops. The connection stop can be caused by a manual action of the user, or by a disconnection due to a communication dysfunction at the level of the user module 5 and/or the analyzing module 8 and/or the controlling unit 4 and/or the user device 9 and/or the controlling device 10.

An end of information can also be received by the analyzing module 8 from the controlling unit 4.

In such a case, the controlling unit 4 can be configured to determine automatically that the user stops the activity corresponding to the instant type of user activity information. It then sends the determined end of activity information to the analyzing module 8.

In a specific embodiment, the system also comprises movement and/or position detection means in wire or wireless communication with the controlling unit 4. When the controlling unit 4 receives from this detection means an absence of movement information or a predetermined type of movement or of succession of movements information, and/or a predetermined position information, it determines automatically that the user stops the activity corresponding to the instant type of user activity information.

The absence of movement information may correspond to a complete absence of movement detected during a predetermined duration. The movement or succession of movements information may correspond to an action to put the system in a specific place, such as, when the system is integrated in, or associated with, a garment (see further below), to hang the garment on a hanger or rack. The position information may correspond to a storage position.

It is desirable to reduce the risk of taking into account irrelevant feedback. For example, in case the feedback information is obtained long after the activity has ended, this feedback information might be irrelevant. As a matter of fact, it is considered that after more than 7 days following the end of activity, the user does not remember well enough the course of the activity to make the feedback information relevant. To avoid this, the duration between stopping the activity and obtaining feedback information should not be too long.

To this end, the analyzing module 8 is configured to measure the duration between the moment when the user stops the activity corresponding to the instant type of user activity information, and the moment when the feedback information is obtained from the user. Then, the analyzing module 8 will analyze the feedback information only if this duration is smaller or equal to a predetermined duration, such as 7 days, preferably 12 hours.

It is also possible to reduce the risk that irrelevant feedback information is taken into account, by configuring the user module 5 to obtain the feedback information only if the time elapsed since the user has stopped the activity corresponding to the instant type of user activity information is smaller or equal to a predetermined duration.

Alternatively, or in combination, the feedback information is obtained by the user module 5 after a predetermined number of sessions of use for a given activity. This also aims to render the feedback more relevant. The number of sessions of use is determined based on the number of times that the user module 5 obtains from the user the instant type of user activity information. The number of sessions of use for a given activity is incremented each time the user module 5 obtains from the user such instant type of user activity information corresponding to the given activity. The feedback information is then obtained by the user module 5, for example by prompting the user to do so on the user interface of the user device 9, only when this number has reached a predetermined value Thus, the user module 5 is configured to obtain the feedback information from the user after having obtained N times from the user an instant type of user activity information corresponding to the same type of user activity. N being greater than 1, preferably equal to 5.

On the other hand, it might become bothering for the user to be asked for giving feedback too many times, such that the value of N must not be too high. It appears that N should preferably be less or equal to 5.

Combining the above two constraints of getting relevant feedback while not over-soliciting the user, leads to prefer that N being comprised between 2 and 5, preferably that N being equal to 5.

This value of N might depend on the type of activity, and/or the profile of the user, and/or other parameters such as environmental parameters.

N is therefore comprised between 2 and a predetermined value greater or equal to 2, preferably equal to this predetermined value. In a preferred embodiment, this predetermined value is equal to 5.

The user module 5 can be in connection with a remote central computer system comprising a memory module 6 and a controlling module 7.

The memory module 6 is configured to store feedback information transmitted by a plurality of systems of temperature regulation, through their corresponding user modules 5. The memory module 6 is also configured to store default thermal responses associated with groups of users and types of user activity.

The controlling module 7 configured to analyze all the feedback information corresponding to a given group of users for a given type of user activity, in order to determine one or more adaptation values, and to adapt the corresponding default thermal response stored in the memory module 6 based on the determined adaptation values.

The controlling unit 4 associated with a given user module 5 is further configured to connect to this remote central computer system, through its controlling module 7, in order to obtain or download a default thermal response corresponding to a given user activity and to a given group of users, when no thermal response for the given user activity is stored in the memory unit 3.

The controlling unit 4 of the temperature regulating system is configured to be powered by a power source. Such power source can transmit power via a wired connection or wirelessly. This power source can be the same power source as a power source of a user device 9 comprising the user module 5. This power source can also be integrated in a device comprising the controlling unit 4. Alternatively again, this power source can also be external to the system.

The temperature regulation system can be integrated in, or associated with, a garment to be worn by a human user or animal user. Here, the term garment extends to accessories to be worn by a user, such as a belt, a wrist lace or a watch, a shoe, etc. Such a garment thus comprises the temperature regulation system which is used to regulate the temperature of at least a part of the body of the user which wears the garment.

In that case, the temperature sensors 1 are disposed on the wearable article such that these temperature sensors 1 are in contact with a portion of the user's body, for example directly in contact with the user's skin, or indirectly in contact with the user's skin through a layer of the garment.

In the case of an animal user, the term user extends to the human user being the owner or master of the animal, or being the person who is working with, or leading, the animal. The user, the body's temperature of which is regulated by the system of the invention, is the animal user, while the user who gives feedback is the human user. For the purpose of the invention, this animal user and this human user form the same user entity.

The above also applies when the user, the body's temperature of which is regulated by the system of the invention, is a physically impaired person or any first person with a reduced autonomy, who is accompanied or assisted by a second person forming the user who gives the feedback. For the purpose of the invention, this first and second persons form the same user entity.

The temperature adjustment elements 2 can be temperature regulating pads positioned on, or in, the garment, and arranged in direct contact with the user's skin or in contact through a layer of textile.

The controlling unit 4, and possibly the memory unit 3, and the analyzing module 8 in the example of FIG. 2, are preferably disposed on the garment. So it is too for the power source. Part or all of these elements may be grouped and integrated into a single electronic device 10, or controlling device 10, which aims at being integrated into a garment.

The above description has been directed to specific embodiments of this invention which is, however, not limited to these embodiments described for purpose of example only. It will be apparent for the man of the art that other variations and modifications may be made to the described embodiments, with obtaining some or all of their advantages. Therefore, it is the object of the appended claims to cover all such variations and modifications.

In particular, the above description relates to a controlling unit 4 and a memory unit 3, in communication with separate temperature sensors 1, separate temperature adjustment elements 2, and separate user module 5. Alternatively, the memory unit 3 may be part of a component comprising the temperature sensors 1 or of a user device comprising the user module 5, and the controlling unit 4 may be part also of such a user device comprising the user module 5.

The above description also relates to a user module 5 being part of a user device 9, and a controlling unit 4 and a memory 6 unit 3 being part of a controlling device 10, with an analyzing module 8 being part either of the user device 9 (FIG. 1) or of the controlling device 10 (FIG. 2). In another embodiment, the analyzing module 8 may be distributed over the user device 9 and the controlling device 10. It may also be part of another distinct device, or it may be distributed over a plurality of devices, amongst which the user device 9 and/or the controlling device 10, or none of these two devices.

It also reminded that the separation into logical parts such as the user module 5, the analyzing module 8 and the controlling unit 4, corresponds to a functional representation of the system of the invention. These different parts may correspond to different logical blocks, implemented in one or another of the devices, such as the user device 9 and the controlling device 10. These different parts may also be implemented in order to be partly or totally mixed in one or more logical block, the latter being implemented in, or distributed over, one or more devices, such as the user device 9 and the controlling device 10.

1. A temperature regulation system for regulating the temperature of a user's body, the temperature regulation system comprising:
at least one temperature sensor (1) adapted to generate a measurement related to an instant temperature of a given portion of a user's body;
at least one temperature adjustment element (2) adapted to provide heat and/or cold to at least a part of the user's body;
a memory unit (3) adapted to store a thermal response in association with one or more types of user activity, said thermal response defining when the temperature adjustment element has to be activated and deactivated based on an instant temperature related value;
a controlling unit (4) in wire or wireless communication with the memory unit (3), with the temperature sensor (1) and with the temperature adjustment element (2), configured, for a given type of user activity, to receive a measurement from the temperature sensor (1), to determine an instant temperature related value from the received measurement, and to activate the temperature adjustment element (2) depending on the thermal response and the instant temperature related value,
wherein the system further comprises a user module (5) and an analyzing module (8) in wire or wireless communication with each other and with the controlling unit (4),
said user module (5) being configured to obtain an instant type of user activity information from the user to indicate that the user starts an activity corresponding to the instant type of user activity information, transmit said instant type of user activity information to the controlling unit (4), obtain feedback information from the user, said feedback information comprising at least one level value associated with at least one indicator related to the working of the system, and transmit said feedback information to the analyzing module (8),
said analyzing module (8) being configured to analyze feedback information to determine one or more adaptation values, adapt the thermal response based on the adaptation values to generate an adapted thermal response, and transmit said adapted thermal response to the controlling unit (4);
said controlling unit (4) being further configured to store the adapted thermal response in the memory unit (3) in association with the type of user activity corresponding to the instant type of user activity information.

2. The system according to claim 1, wherein the analyzing module (8) is configured to measure the duration of use of the system after the user module (5) obtains from the user the instant type of user activity information, and to transmit said duration of use to the user module (5), said user module (5) being configured to obtain the feedback information from the user when said duration of use is greater than a predetermined duration.

3. The system according to any of claims 1 and 2, wherein the analyzing module (8) is further configured to determine when the user stops the activity corresponding to the instant type of user activity information, and to transmit to the user module (5) an information that the user has stopped the activity corresponding to the instant type of user activity information, said user module (5) being configured to obtain the feedback information from the user after the user has stopped said activity corresponding to the instant type of user activity information.

4. The system according to claim 3, wherein the analyzing module (8) is further configured to obtain an end of activity information from the user in order to determine when the user stops the activity corresponding to the instant type of user activity information.

5. The system according to any of claims 3 and 4, wherein the user module (5) and the analyzing module (8) are further configured to establish a connection with the controlling unit (4) before any communication with said controlling unit (4), the analyzing module (8) being configured to obtain an end of activity information when said connection stops, in order to determine when the user stops the activity corresponding to the instant type of user activity information.

6. The system according to any of claims 3 to 5, wherein the analyzing module (8) is further configured to obtain an end of activity information from the controlling unit (4) in order to determine when the user stops the activity corresponding to the instant type of user activity information.

7. The system according to claim 6, wherein the controlling unit (4) is further configured to determine automatically that the user stops the activity corresponding to the instant type of user activity information, and to send the end of activity information to the analyzing module (8) accordingly.

8. The system according to claim 7, further comprising movement and/or position detection means in wire or wireless communication with the controlling unit (4), the controlling unit (4) being further configured to determine automatically that the user stops the activity corresponding to the instant type of user activity information by receiving from said detection means an absence of movement information or a predetermined type of movement or of succession of movements information, and/or an predetermined position information.

9. The system according to any of claims 3 to 8, wherein the analyzing (8) is configured to measure a duration between the moment when the user stops the activity corresponding to the instant type of user activity information, and the moment when the feedback information is obtained from the user, and to analyze the feedback information only if said duration is smaller or equal to a predetermined duration.

10. The system according to any of claims 3 to 9, wherein the user module (5) is configured to obtain the feedback information only if the time elapsed since the user has stopped the activity corresponding to the instant type of user activity information is smaller or equal to a predetermined duration.

11. The system according to any of claims 1 to 10, wherein the user module (5) is configured to obtain the feedback information from the user after having obtained N times from the user an instant type of user activity information corresponding to the same type of user activity, where N is comprised between 2 and a predetermined value p, preferably N is equal two p, with p being greater than 2, preferably p being equal to 5.

12. The system according to any of claims 1 to 11, wherein the thermal response is defined at least by a start temperature value, a stop temperature value, and an electrical power value, the controlling unit (4) being configured to activate the temperature adjustment element (2) with an electrical power corresponding to the electrical power value, when the instant temperature is smaller or equal to the start temperature value, and to deactivate the temperature adjustment element (2) when the instant temperature is greater than the stop temperature value.

13. The system according to claim 12, wherein at least one of the indicators is related to the start temperature or to the stop temperature or to the electrical power.

14. The system according to any of claims 12 to 13, wherein the analyzing module (8) is configured to analyze the level corresponding to the indicator in the feedback information to determine a corresponding adaptation value, and to modify the start temperature value or the stop temperature value, or the electrical power value, based on the corresponding adaptation value.

15. The system according to any of claims 1 to 14, further comprising a user device (9) and a controlling device (10), the user module (5) being part of the user device (9), the controlling unit (4) being part of the controlling device (10), the analyzing module (8) and the memory (3) being part of the user device (9) or the controlling device (10) or being distributed in the user device (9) and the controlling device (10).

16. The system according to any of claims 1 to 15, wherein the user module (5) is further configured to transmit the feedback information to a remote central computer system configured to adapt a default thermal response associated with a group of users and with the type of user activity corresponding to the instant type of user activity information, based on the feedback information.

17. The system according to claim 16, wherein the controlling unit (4) is further configured to connect to the remote central computer system, to download from said remote central computer system a default thermal response corresponding to a given user activity and to a given group of users when no thermal response for the given user activity is stored in the memory unit (3), and to store said default thermal response in said memory (3).

18. A central computer system comprising a memory module (6) configured to store feedback information transmitted by a plurality of systems according to any of claims 16 and 17, and to store default thermal responses associated with groups of users and types of user activity, and comprising a controlling module (7) configured to analyze all the feedback information corresponding to a given group of users for a given type of user activity to determine one or more adaptation values, and to adapt the corresponding default thermal response stored in the memory module (6) based on the determined adaptation values.

19. Garment to be worn by a user comprising a temperature regulation system in accordance with any of claims 1 to 17.

20. A method for regulating the temperature of a user's body, comprising:
generating, using at least one temperature sensor (1), a measurement related to an instant temperature of a given portion of a user's body;
providing, using at least one temperature adjustment element (2), heat and/or cold to at least a part of the user's body;
storing, in a memory unit (3), a thermal response in association with one or more types of user activity, said thermal response defining when the temperature adjustment element (2) has to be activated and deactivated based on an instant temperature related value;
receiving, using a controlling unit (4) in wire or wireless communication with the memory unit (3), with the temperature sensor (1) and with the temperature adjustment element (2), for a given type of user activity, a measurement from the temperature sensor (1),
determining, using said controlling unit (4), an instant temperature value from the received measurement; and
and activating, using said controlling unit (4), the temperature adjustment element (2) depending on the thermal response and the instant temperature related value,
wherein the method further comprises
obtaining, using a user module (5) in wire or wireless communication with the controlling unit (4), an instant type of user activity information from the user to indicate that the user starts an activity corresponding to the instant type of user activity information;
transmitting, using said user module (5), said instant type of user activity information to the controlling unit (4);
obtaining, using said user module (5), feedback information from the user, said feedback information comprising at least one level value associated with at least one indicator related to the working of the system;
transmitting, using said user module (5), said feedback information to an analyzing module (8) in wire or wireless communication with the controlling unit (4) and the user module (5);
analyzing, using said analyzing module (8), the feedback information to determine one or more adaptation values;
adapting, using said analyzing module (8), the thermal response based on the adaptation values for generating an adapted thermal response;
transmitting, using said analyzing module (8), the adapted thermal response to the controlling unit (4); and
storing, using the controlling unit (4), the adapted thermal response in the memory unit (3) in association with the type of user activity corresponding to the instant type of user activity information.

21. The method according to claim 20, further comprising
measuring, using the analyzing module (8), the duration of use of the system after having obtained from the user the instant type of user activity information,
transmitting, using said analyzing module (8), said duration of use to the user module (5),
obtaining, using said user module (5), the feedback information from the user when the duration of use is greater than a predetermined duration.

22. The method according to any of claims 20 and 21, further comprising
determining, using the analyzing module (8), when the user stops the activity corresponding to the instant type of user activity information,
transmitting, using said analyzing module (8), an information that the user has stopped the activity corresponding to the instant type of user activity information to the user module (5),
obtaining, using said user module (5), the feedback information from the user is after the user has stopped said activity corresponding to the instant type of user activity information.

23. The method according to claim 22, further comprising obtaining, using the analyzing module (8), an end of activity information from the user in order to determine when the user stops the activity corresponding to the instant type of user activity information.

24. The method according to any of claims 22 and 23, further comprising
establishing, using the user module (5), a connection with the controlling unit (4) before any communication with said controlling unit (4),
obtain, using the analyzing module (8), an end of activity information when said connection stops, in order to determine when the user stops the activity corresponding to the instant type of user activity information.

25. The method according to any of claims 22 to 24, further comprising obtaining, using the analyzing module (8), an end of activity information from the controlling unit (4) in order to determine when the user stops the activity corresponding to the instant type of user activity information.

26. The method according to claim 25, further comprising
determining automatically, using the controlling unit (4), that the user stops the activity corresponding to the instant type of user activity information, and
sending, using said controlling unit, the end of activity information to the analyzing module (8) accordingly.

27. The method according to claim 26, further comprising
receiving, using the controlling unit (4), from a movement and/or position detection means in wire or wireless communication with the controlling unit (4), an absence of movement information or a predetermined type of movement or of succession of movements information, and/or an predetermined position information,
determining automatically, using the controlling unit (4), that the user stops the activity corresponding to the instant type of user activity information, based on the information received from said detection means.

28. The method according to any of claims 22 to 27, further comprising
measuring, using the analyzing (8), a duration between the moment when the user stops the activity corresponding to the instant type of user activity information, and the moment when the feedback information is obtained from the user,
analyzing, using said analyzing module (8), the feedback information only if said duration is smaller or equal to a predetermined duration.

29. The method according to any of claims 22 to 28, further comprising obtaining, using the user module (5), the feedback information only if the time elapsed since the user has stopped the activity corresponding to the instant type of user activity information is smaller or equal to a predetermined duration.

30. The method according to any of claims 20 to 29, further comprising obtaining, using the user module (5), the feedback information from the user after having obtained N times from the user an instant type of user activity information corresponding to the same type of user activity, where N is comprised between 2 and a predetermined value p, preferably N is equal two p, with p being greater than 2, preferably p being equal to 5.

31. The method according to any of claims 20 to 30, wherein the thermal response is defined at least by a start temperature value, a stop temperature value, and an electrical power value, the method further comprising
activating, using the controlling unit (4), the temperature adjustment element (2) with an electrical power corresponding to the electrical power value, when the instant temperature is smaller or equal to the start temperature value,
deactivating, using the controlling unit (4), the temperature adjustment element (2) when the instant temperature is greater than the stop temperature value.

32. The method according to claim 31, wherein at least one of the indicators is related to the start temperature or to the stop temperature or to the electrical power.

33. The method according to any of claims 31 to 32, further comprising
analyzing, using the analyzing module (8), the level corresponding to the indicator in the feedback information to determine a corresponding adaptation value,
modifying, using said analyzing module (8), the start temperature value or the stop temperature value, or the electrical power value, based on the corresponding adaptation value.

34. The method according to any of claims 20 to 33, further comprising
transmitting, using the user module (5), the feedback information to a remote central computer system,
adapting, using said remote central computer, a default thermal response associated with a group of users and with the type of user activity corresponding to the instant type of user activity information, based on the feedback information.

35. The method according to claim 34, further comprising
connecting, using the controlling unit (4), to the remote central computer system,
downloading from said remote central computer system, using said controlling unit (4), a default thermal response corresponding to a given user activity and to a given group of users when no thermal response for the given user activity is stored in the memory unit (3).

36. A method according to any of claims 34 and 35, further comprising using a memory module (6) of the central computer system for storing feedback information received from a plurality of systems according to any of claims 16 and 17, and for storing default thermal responses associated with groups of users and types of user activity, and using a controlling module (7) of said central computer system for analyzing all the feedback information corresponding to a given group of users for a given type of user activity to determine one or more adaptation values, and for adapting the corresponding default thermal response stored in the memory module (6) based on the determined adaptation values.
